(19) United States
(12) Patent Application Publication
(10) Pub. No.: US 2009/0151557 A1
(43) Pub. Date: Jun. 18, 2009

(54) DEHUMIDIFICATION SYSTEM AND DEHUMIDIFICATION METHOD IN BOOSTER PIPING

(75) Inventor: Toshihiro SUZUKI, Tsukubamirai-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SMC Corporation, Chiyoda-ku (JP)

(21) Appl. No.: 12/331,770

(22) Filed: Dec. 10, 2008

(30) Foreign Application Priority Data
Dec. 18, 2007 (JP) 2007-325653

(51) Int. Cl. B01D 53/26; B01D 53/22

(52) U.S. Cl. 95/52; 96/6

(57) ABSTRACT

Compressed air is supplied to a booster after the compressed air at high pressure is dehumidified by means of a hollow thread membrane of a membrane dryer, and a part of the compressed air is used to serve as the compressed air for a boosting operation, and thereby the compressed air is boosted by the booster, and the used discharge air that is used for the boosting operation is caused to flow through a purge flow path formed on an outside of the hollow thread membrane of the membrane dryer, and the discharge air is utilized to serve as purge air.

### TECHNICAL FIELD

The present invention relates to a dehumidification system and a dehumidification method in booster piping, configured to utilize the used discharge air at low pressure and low humidity that is used for a boosting operation for compressed air in a booster, to serve as purge air for a membrane dryer.

### BACKGROUND ART

Hitherto, a booster in which compressed air is caused to flow into a drive chamber and a booster chamber of a booster, and the compressed air whose pressure is boosted in the booster chamber by pressure of the drive chamber is supplied into a fluid pressure device is known according to Japanese Unexamined Utility Model Registration Application Publication No. 61-32801. In this booster, the discharge air of the drive chamber at low pressure, which is used for boosting the compressed air in the booster chamber, is discharged outside.

Further, various membrane dryers (membrane-type dehumidification apparatus), in which the high-pressure compressed air to be dehumidified is caused to flow through an inside flow path of a hollow thread membrane, and purge air at low pressure and low humidity is caused to flow through a purge flow path outside the hollow thread membrane, and moisture in the compressed air to be dehumidified is dehumidified by transmitting the compressed air through the hollow thread membrane corresponding to steam-partial pressure on both of inside and outside of the hollow thread membrane, and the dehumidified compressed air is supplied to the fluid pressure device, and further, a part of the dehumidified compressed air is used to serve as the aforementioned purge air, is known (refer to Japanese Unexamined Utility Model Registration Application Publication No. 02-70718 for example).

Since the aforementioned booster is constructed such that the used air that is used for boosting the air pressure is discharged to ambient air by necessity, and the aforementioned membrane dryer is constructed to utilize the part of the dehumidified compressed air to serve as the purge air, in a case that the compressed air that is dehumidified by means of the aforementioned membrane dryer is used upon boosting the air pressure by means of the booster, a large amount of air in the once compressed air is discharged to the ambient air, and this results in a problem in a viewpoint of energy-saving. This problem naturally applies to a case in which the membrane dryer and the booster are used in a same line, and even in a case that respective positions of the membrane dryer and the booster, which are disposed on different lines, are located close to each other, this problem also applies.

### DISCLOSURE OF INVENTION

A technical problem of the present invention is to efficiently aim at energy-saving by means of reducing the amount of the air that is discharged from the membrane dryer and the booster in the ambient air in the once compressed air, in a case that the compressed air that is dehumidified by means of the membrane dryer is used upon boosting the air pressure thereof by means of the booster, and the like case.

In order to solve the aforementioned problem, a dehumidification system in booster piping with respect to the present invention includes a membrane dryer including, an inlet port and an output port that is led to both ends of an inside flow path of a plurality of hollow thread membrane, a purge flow path formed on an outside of the hollow thread membrane, a purge flow path inlet portion and a purge flow path outlet portion respectively positioned at both end portions of the purge flow path, and an extraneous purge inlet port that is allowed to communicate with the purge flow path inlet portion; a booster including, an inlet for introducing compressed air, a drive chamber and a booster chamber into which the compressed air from the inlet flows, an outlet from which the compressed air boosted in the booster chamber by means of pressure of the drive chamber is discharged, and a discharge outlet from which the used discharge air at low pressure, which is used for a boosting operation in the drive chamber, is discharged; first piping causing the dehumidified compressed air discharged from the outlet port of the membrane dryer to flow toward the inlet of the booster; and second piping causing the discharge air, which is used for a boosting operation, discharged from the discharge outlet of the booster to flow toward the purge flow path of the membrane dryer.

In the dehumidification system with respect to the present invention, it is preferable for the outlet port and the purge flow path inlet portion of the aforementioned membrane dryer to be connected by means of a communicating path having an orifice.

In this case, the aforementioned purge flow path may be provided in an inside of a U-shaped flow path case housing the aforementioned hollow thread membrane upon curving the same, and both ends of the flow path case are coupled with the casing main body of the membrane dryer having the inlet port and the outlet port, and the aforementioned orifice may be provided inside the casing main body, or alternatively, the aforementioned purge flow path may be provided inside the flow path case formed to have a straight hollow-cylinder shape housing the aforementioned hollow thread membrane.

Further, in the aforementioned dehumidification system with respect to the present invention, an oil separation filter may be provided in the piping for causing the discharge air from the discharge outlet of the booster to flow toward the purge flow path of the aforementioned membrane dryer.

On the other hand, the dehumidification method with respect to the present invention is characterized in that the compressed air at high pressure, to be dehumidified, is dehumidified by causing to flow into an inside flow path of a plurality of hollow thread membrane of the membrane dryer, and the dehumidified compressed air is caused to flow into a drive chamber and a booster chamber of a booster, and the compressed air that is boosted in the booster chamber by means of pressure in the drive chamber is supplied to a fluid pressure device, and the used discharge air at low pressure that is used for a boosting operation in the drive chamber is caused to flow to a purge flow path provided on an outside of the hollow thread membrane of the membrane dryer.

In the aforementioned dehumidification method, a part of the compressed air dehumidified by the aforementioned membrane dryer can be caused to flow through the aforementioned purge flow path upon depressurized.

In the dehumidification system and dehumidification method with respect to the present invention having the aforementioned construction, since the membrane dryer and the booster are used, and the used discharge air at low pressure and low humidity, which is discharged from the drive chamber of the booster, is caused to flow through the purge flow path on the outside of the hollow thread membrane of the membrane dryer, the flowing amount is sufficient for the purge air, and in addition since the aforementioned discharge air is previously dehumidified, there is no need to directly use the part of the compressed air, which is dehumidified by the membrane dryer to serve as the purge air, and therefore the amount of discharge air can be reduced.

However, although the purge air serving as the discharge air of the booster is lost during the time the booster is not in operation in a case that, for example, there is no consumption of the compressed air in the air pressure device connected to the secondary side of the booster or the like, an effective dehumidification operation can be performed even when the compressed air starts to flow into the hollow thread membrane and the booster starts operation, by means of constructing that a small flowing amount of the compressed air dehumidified by means of the membrane dryer to be caused to flow so that a small amount of the compressed air becomes usable to serve as the purge air, or alternatively, by means of constructing that the small flowing amount thereof is caused to flow through a valve or the like corresponding to the necessity so that the steam-partial pressure of the purge flow path becomes possible to be constantly lowered.

In a case that the oil content, such as grease, or the like in the booster is required to be suppressed to be brought into the purge flow path, it is sufficient to provide the above-described oil separation filter, and thereby lowering of the capability of the hollow thread membrane can be suppressed.

In accordance with the above-described dehumidification system and the dehumidification method with respect to the present invention, in a case that the compressed air dehumidified by means of the membrane dryer is used upon boosting by means of the booster, an amount of the compressed air discharged to the ambient air from the membrane dryer and the booster in the once compressed air is reduced, and thereby energy-saving can be efficiently aimed at.

### BRIEF DESCRIPTION OF DRAWINGS

FIG. 1 is a construction view in which an important part of a first embodiment of the present invention is illustrated in a broken manner.

FIG. 2 is a construction view in which an important part of a second embodiment of the present invention is illustrated in a broken manner.

FIG. 3 is a schematic construction view illustrating a booster used in the first and second embodiments of the present invention.

### BEST MODES FOR CARRYING OUT THE INVENTION

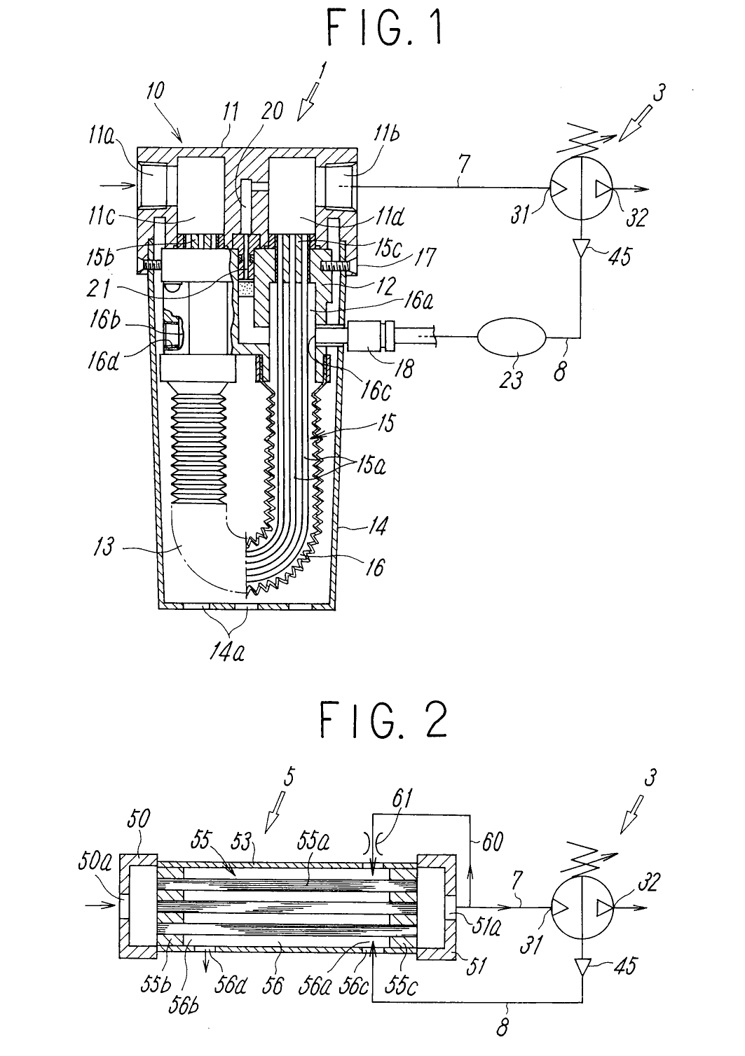

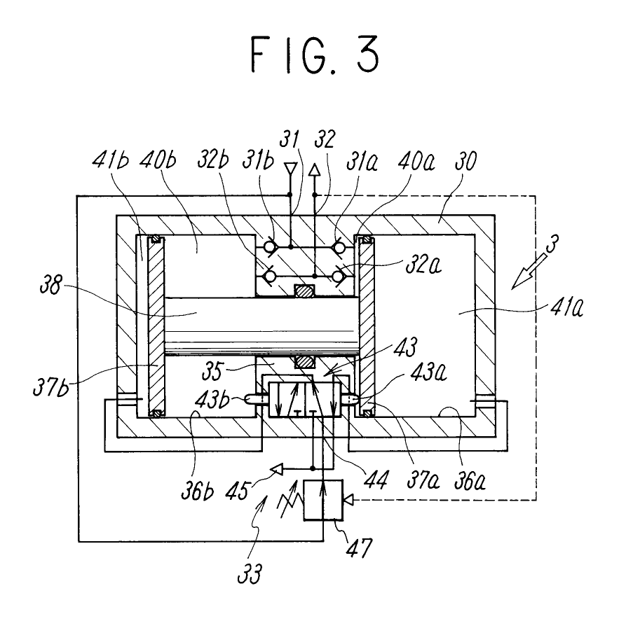

A first embodiment of a dehumidification system in booster piping with respect to the present invention will be explained with reference to FIG. 1 and FIG. 3.

In the dehumidification system of the first embodiment, a membrane dryer (membrane-type dehumidification apparatus) 1 and a booster 3 which is illustrated with a symbol mark in FIG. 1, are provided on an air pressure line led from a not-illustrated pressurized air source to an arbitrary fluid pressure device, and the aforementioned membrane dryer 1 and the booster 3 are connected by means of first piping 7 and second piping 8. The aforementioned first piping 7 is provided for allowing compressed air that is dehumidified by means of the aforementioned membrane dryer 1 to flow toward an inlet 31 of the aforementioned booster 3, and the aforementioned second piping 8 is provided for leading used discharge air, which is discharged from a discharge outlet 45 after being used for a boosting operation performed in the aforementioned booster 3, to a purge flow path 16 of the aforementioned membrane dryer 1.

The aforementioned membrane dryer 1 includes a casing main body 10, and the casing main body 10 is constructed with a main body 11 provided with an inlet port 11a and an outlet port 11b connected to the aforementioned air pressure line, and a flow path body 12 forming a purge flow path inlet portion 16a, a purge flow path outlet portion 16b, and the like, by being connected to the main body 11. Both ends of a bellows-shaped flow path case 13 that is curved in a U-shaped manner is coupled with the aforementioned inlet port 11a and the outlet port 11b, respectively, via the aforementioned flow path body 12, and a membrane module 15 composed of a plurality of hollow thread membranes 15a is housed in an inside of the flow path case 13, in a state of allowing both end portions of an inside flow path of the aforementioned hollow thread membrane 15a to communicate with the aforementioned inlet port 11a and the outlet port 11b. A protection cover 14 formed to have a tubular shape or a box shape in a manner so as to cover the aforementioned flow path case 13 is attached to the aforementioned casing main body 10. Further, an outside of the hollow thread membrane 15a in the aforementioned flow path case 13 forms a purge flow path 16, and an end portion on the aforementioned outlet port 11b side of the purge flow path 16 forms the aforementioned purge flow path inlet portion 16a, and an end portion on the inlet port 11a side of the aforementioned purge flow path 16 forms the aforementioned purge flow path outlet portion 16b. An extraneous purge inlet port 16c connected to the discharge outlet 45 of the aforementioned booster 3 is provided at the aforementioned purge flow path inlet portion 16a, and the aforementioned purge flow path outlet portion 16b is opened in the aforementioned protection cover 14 by means of a through hole 16d.

Further concretely explaining the aforementioned construction, the casing main body 10 of the aforementioned membrane dryer 1 is formed by integrally connecting the aforementioned main body 11 and the aforementioned flow path body 12, and the aforementioned inlet port 11a and the aforementioned outlet port 11b are formed in the aforementioned main body 11 in a manner so as to open in directions opposite to each other. An open end at an upper part of the aforementioned protection cover 14 is fitted into an outside of a peripheral wall of the aforementioned flow path body 12, and a fitting portion thereof is fixed with a plurality of screws 17. Moreover, the aforementioned membrane module 15 is constructed by means of fixing both ends of a bundle of a plurality of hollow thread membrane 15a formed of a steam-transmitting membrane with firmly fixing sealing members 15b and 15c. The aforementioned firmly fixing sealing members 15b and 15c are air-tightly fitted and fixed into an opening of the flow path body 12 that is allowed to communicate with communicating opening portions 11c and 11d of the aforementioned main body 11, in a manner such that both end portions of the inside flow path of the aforementioned hollow thread membrane 15a is opened toward the communicating opening portions 11c and 11d, which are allowed to communicate with the aforementioned inlet port 11a and outlet port 11b.

A pipe joint 18 penetrates a side portion of the aforementioned protection cover 14 and fixed in a manner such that a tip end thereof reaches the extraneous purge inlet port 16c of the aforementioned flow path body 12. This pipe joint 18 is provided for connecting the aforementioned second piping 8 that connects the discharge outlet 45 of the booster 3 and the aforementioned extraneous purge inlet port 16c of the membrane dryer 1. Further, when the discharge air that is discharged from the aforementioned discharge outlet 45 is introduced from the aforementioned extraneous purge inlet port 16c to the purge flow path inlet portion 16a to serve as the purge air by means of the second piping 8, the purge air is configured to bear the moisture separated in the purge flow path 16 by means of the hollow thread membrane 15a, and to flow into the protection cover 14 through the purge flow path outlet portion 16b and the through hole 16d, and to be discharged outside from a discharge hole 14a that is provided at a bottom portion of the protection cover 14.

Although the used discharge air supplied from the booster 3 is sufficient for the purge air that is required by the aforementioned membrane dryer 1, at a stage when the fluid pressure device that is connected to the secondary side of the booster 3 does not consume the pressure-boosted compressed air, there is no flowing amount of the discharge air from the booster 3 and the purge air does not flow. However, in the membrane dryer 1, it is preferable to keep an outside surface of the hollow thread membrane 15a in a dried state by always causing a small amount of the purge air to flow through the purge flow path 16 so that a dew point of the compressed air is promptly lowered with ease when the compressed air is caused to flow through an inside flow path of the hollow thread membrane 15a when an operation of the booster 3 is restarted. In consideration of the above-described, it is preferable to configure a part of the dehumidified compressed air to be caused to flow through the purge flow path 16 regardless of the booster 3.

In consideration of the above view point, in the aforementioned membrane dryer 1, a communicating flow path 20 allowing the communicating opening portion 11d, which is allowed to communicate with the outlet port 11b, and the purge flow path inlet portion 16a to communicate with each other is provided in the aforementioned main body 11 and the flow path body 12. An orifice 21 is disposed in the communicating path 20, and the outlet port 11b and the purge flow path inlet portion 16a are connected by a flow path including the orifice 21. In general, a flow amount of air flowing through the orifice 21 is set in a manner such that a minimal amount of the compressed air in the dehumidified compressed air flows through the aforementioned flow path and flows through the purge flow path inlet portion 16a upon being depressurized by means of the orifice 21. Incidentally, although the illustrated orifice 21 is that of a fixed choke, the same can be formed to be that of a variable choke where the choking amount is adjusted from outside the membrane dryer 1.

Further, although the discharge air from the booster 3 is introduced into the aforementioned purge flow path 16, there is a possibility that an oil content, such as grease, or the like in the booster is contained in the discharge air, and therefore when there is a necessity to remove the same for maintaining a capability of the hollow thread membrane 15a, it is sufficient to provide an oil separation filter 23 in the second piping 8 for the discharge air from the booster 3.

In the membrane dryer 1 having the aforementioned construction, when the compressed air to be dehumidified is supplied from the inlet port 11a, the compressed air passes through from the communicating opening portion 11c of the main body 11 to the inside of the hollow thread membrane 15a and is dehumidified, and reaches the outlet port 11b serving as dried compressed air. Moreover, the moisture that has seeped out to the purge flow path 16 while permeating the hollow thread membrane 15a is conveyed to the outside by means of the purge air at low humidity, which is headed for the purge flow path outlet portion 16b upon flowing into the purge flow path 16 from the purge flow path inlet portion 16a and passing therethrough.

The aforementioned booster 3 serving as a component of the aforementioned dehumidification system is, schematically, formed for boosting the pressure of the dried compressed air, which is outputted from the outlet port 11b of the aforementioned membrane dryer 1, and is constructed as illustrated in FIG. 3. That is, the booster 3 is constructed by providing a pair of booster chambers 40a and 40b, an inlet 31 for causing the aforementioned dried compressed air to flow into the booster chambers 40a and 40b through an inlet check valves 31a and 31b, an outlet 32 that outputs the boosted compressed air so as to supply the same to various fluid pressure devices through outlet check valves 32a and 32b, and a booster mechanism 33 for boosting the compressed air caused to flow into the aforementioned booster chambers 40a and 40b in a booster main body 30. The aforementioned booster mechanism 33 is formed to discharge the used compressed air, which is used for boosting the compressed air, to the outside after gradually boosting the compressed air that is allowed to flow into the aforementioned boosting chambers 40a and 40b, by means of supplying/discharging the pressure of the compressed air itself, which is supplied into the aforementioned inlet 31, to the drive chambers 41a and 41b for boosting the compressed air.

The booster 3 and the booster mechanism 33 thereof illustrated in FIG. 3 will be further concretely explained. The aforementioned booster main body 30 includes a pair of cylinders 36a and 36b that are partitioned by means of a partition wall 35 at a center of an inside thereof. Pistons 37a and 37b are respectively disposed in the cylinders 36a and 36b, and the pistons 37a and 37b are coupled by means of a rod 38 that is air-tightly penetrating the aforementioned partition wall 35 with each other. Further, a pair of pressure chambers positioned on inner surface sides of the aforementioned respective pistons 37a and 37b in the aforementioned cylinders 36a and 36b, namely on the partition wall 35 sides serve as booster chambers 40a and 40b, and a pair of pressure chambers positioned on outer surface sides of the aforementioned respective pistons 37a and 37b serve as drive chambers 41a and 41b. Incidentally, the positions of the aforementioned booster chambers and the drive chambers can be constructed in an opposite manner. In this case, the booster mechanism explained below has to apply to the positions described above.

The aforementioned booster chambers 40a and 40b are, as described above, allowed to communicate with the inlet 31 into which the dried compressed air to be boosted is caused to flow via the inlet check valves 31a and 31b, and are allowed to communicate with the outlet 32 via the outlet check valves 32a and 32b in order to supply the boosted compressed air to the various fluid pressure devices. Although the aforementioned inlet check valves 31a and 31b allow the compressed air in the inlet 31 to flow into the booster chambers 40a and 40b, it blocks a counter flow of the compressed air. Furthermore, although the outlet check valves 32a and 32b allow the air that is boosted by compression in the booster chambers 40a and 40b to flow out toward the outlet 32, it blocks the counter flow of the boosted air.

On the other hand, each of the aforementioned drive chambers 41a and 41b is configured to be alternately connected to either a supplying inlet 44 or the discharge outlet 45 of the switching valve 43 by means of a switching operation of the switching valve 43. The aforementioned supplying inlet 44 of the switching valve 43 is allowed to communicate with the aforementioned first piping 7 of the compressed air, which is led to the inlet 31 of the aforementioned booster main body 30, and the aforementioned discharge outlet 45 is allowed to communicate with the aforementioned second piping 8 and is configured to cause the used compressed air from the aforementioned drive chambers 41a and 41b to flow toward the extraneous purge inlet port 16c of the membrane dryer 1 from the second piping 8 passing through the aforementioned pipe joint 18.

The aforementioned switching valve 43 is, as illustrated with a symbol mark in FIG. 3, provided in the partition wall 35 of the booster main body 30, and a valve body that switches the flow path is provided with push rods 43a and 43b projecting inside the aforementioned cylinders 36a and 36b on both ends thereof. The aforementioned valve body is displaced and the flow path is thereby switched when the push rods 43a and 43b are pressed by means of the pistons 37a and 37b. That is, when the compressed air is supplied into the drive chamber 41a or 41b, the aforementioned pistons 37a and 37b is displaced and the compressed air in either the booster chamber 40a or 40b is boosted. In addition, when the boosted compressed air is outputted from the aforementioned booster chamber 40a or 40b and the outputting operation is completed, the aforementioned piston 37a or 37b presses the push rod 43a or 43b and the switching valve 43 is switched, and thereby the drive chamber 41a or 41b allowed to communicate with the supplying inlet 44 of the switching valve 43 is allowed to communicate with the discharge outlet 45, and the drive chamber 41b or 41a that has been allowed to communicate with the discharge outlet 45 of the switching valve 43 is allowed to communicate with the supplying inlet 44, and this operation is alternatively repeated.

Incidentally, a pressure-adjusting valve 47 is configured to be connected to the flow path that is led to the supplying inlet 44 of the switching valve 43, and the pressure at the outlet 32 is configured to be fed back to the pressure-adjusting valve 47. Thereby, the pressure to be supplied to the aforementioned drive chambers 41a and 41b can be adjusted so that the pressure at the outlet 32 becomes constant.

In the booster 3 having the aforementioned construction, when the compressed air is supplied to the drive chamber 41a and the booster chamber 40b, and the compressed air in the drive chamber 41b is discharged as illustrated in FIG. 3, both of the pistons 37a and 37b move toward a left side, and the compressed air in the aforementioned booster chamber 40a is compressed and boosted by the force generated in both of the pistons 37a and 37b by means of in operation of the compressed air in the aforementioned drive chamber 41a and the booster chamber 40b. Further, the boosted compressed air is outputted from the booster chamber 40a. FIG. 3 illustrates a state in which the outputting operation of the compressed air that is boosted in the booster chamber 40a is completed. When the booster 3 is switched to this state, the piston 37a presses the push rod 43a and switches the switching valve 43, and as a result, by means of the switching operation, as illustrated in the same drawing, the supplying inlet 44 of the switching valve 43 becomes to be allowed to communicate with the drive chamber 41b and the discharge outlet 45 becomes to be allowed to communicate with the drive chamber 41a. As a result, the compressed air from the supplying inlet 44 is supplied to the drive chamber 41b, and at the same time, the compressed air in the drive chamber 41a is discharged to the outside while passing through the discharge outlet 45, and thereby both of the pistons move toward a right side by the force generated in the pistons 37a and 37b by means of an operation of the compressed air that flows into the drive chamber 41b and the compressed air in the booster chamber 40a, and the compressed air in the booster chamber 40b is boosted. Further, the boosted compressed air is sent out from the outlet 32 passing through the outlet check valve 32b.

When the piston 37b presses the push rod 43b by the rightward movement of the piston 37b and the switching valve 43 is switched, supply air flows into the drive chamber 41a from the switching valve 43 and at the same time the compressed air in the drive chamber 41b is discharged from the discharge outlet 45 of the switching valve 43, and the piston 37a moves toward the left side by being pressed by means of the compressed air in the drive chamber 41a and the compressed air in the booster chamber 40b. Thereby, the air in the booster chamber 40a is boosted and the boosted air is sent out from the outlet 32 passing through the outlet check valve 32a. Hereinafter, this operation is repeated.

The booster mechanism 33 in the aforementioned booster 3 supplies the compressed air into either one of the drive chamber 41a or 41b by means of the operation of the switching valve 43 and applies the air pressure to the pistons 37a and 37b coupled with each other by means of the rod 38, and generates drive force by applying the air pressure of the compressed air that flows into the booster chambers 40b or 40a. Further, the booster mechanism 33 boosts the compressed air in the booster chamber 40a or 40b by means of the drive force, and discharges the compressed air in the drive chamber, which is used for a boosting operation, to the outside. Furthermore, the construction of the booster mechanism 33 can be freely modified under the premise that the booster mechanism 33 is provided with a function that a part of the compressed air itself to be boosted is used for the boosting operation.

Moreover, the used compressed air, which is used for the boosting operation in the aforementioned drive chambers 41a and 41b, is previously formed to be the compressed air at low humidity by the membrane dryer 1 and therefore the used compressed air can be effectively utilized to serve as the purge air at low humidity by means of supplying to the purge flow path of the membrane dryer 1 from the discharge outlet 45 passing through the second piping 8 and the extraneous purge inlet port 16c.

FIG. 2 illustrates a second embodiment of the present invention. Incidentally, since the booster 3 in the second embodiment is the same as that in the first embodiment explained with reference to FIG. 3, the explanation of the booster 3 is omitted.

A dehumidification system of the second embodiment illustrated in FIG. 2 is provided with a membrane dryer 5 and the booster 3, and the membrane dryer 5 and the booster 3 are connected by means of the first piping 7 that causes the compressed air that is dehumidified by the aforementioned membrane dryer 5 to flow toward the inlet 31 of the aforementioned booster 3, and the second piping 8 that introduces the used discharge air that is used for the boosting operation, which is discharged from the discharge outlet 45 of the booster 3 to the purge flow path 56 of the membrane dryer 5. Thereby, the compressed air supplied from the aforementioned membrane dryer 5 to the booster 3 is supplied to an arbitrary fluid pressure device upon being boosted in the same manner is explained in the first embodiment and the used discharge air at low humidity that is used for the boosting operation is supplied to the purge flow path 56 of the membrane dryer 5 passing through the aforementioned second piping 8, and is utilized to serve as the purge air.

The aforementioned membrane dryer 5 is provided with an inlet side casing main body 50 having an inlet port 50a, which is connected to an air pressure line headed for the arbitrary fluid pressure device, an outlet side casing main body 51 having an outlet port 51a, which is connected to the inlet 31 of the aforementioned booster 3, a flow path case 53 formed to have a straight hollow-cylinder shape whose both ends are coupled with the inlet side casing main body 50 and the outlet side casing main body 51, respectively, and a membrane module 55 housed in the flow path case 53 and formed of a plurality of hollow thread membrane 55a whose both end portions of the inside flow path are allowed to communicate with the inlet port 50a of the aforementioned inlet side casing main body 50 and the outlet port 51a of the outlet side casing main body 51, respectively. The aforementioned hollow thread membrane 55a formed of a steam-transmitting membrane forms the aforementioned membrane module 55 by means of fixing both end portions of a bundle of the plurality thereof with firmly combining seal members 55b and 55c. An inside flow path of the aforementioned hollow thread membrane 55a is allowed to communicate with the outlet port 51a of the outlet side casing main body 51 and the inlet port 50a of the inlet side casing main body 50 by means of air-tightly fitting and fixing the firmly combining seal members 55b and 55c to an outlet side and an inlet side of the flow path case 53, respectively.

Further, in an inside of the aforementioned flow path case 53, a purge flow path 56 is formed on an outside of the hollow thread membrane 55a, and an end portion of the purge flow path 56 on the aforementioned outlet side casing main body 51 side is formed to be a purge flow path inlet portion 56a, and an end portion of the purge flow path 56 on the aforementioned inlet side casing main body 50 side is formed to be a purge flow path outlet portion 56b. On the aforementioned purge flow path inlet portion 56a side of the aforementioned flow path case 53, an extraneous purge inlet port 56c to be connected to the discharge outlet 45 of the aforementioned booster 3 is provided, and on the aforementioned purge flow path outlet portion 56b side of the aforementioned flow path case 53, a purge discharge outlet 56d is provided.

Moreover, in the aforementioned membrane dryer 5, communicating path 60 causing a part of the dehumidified compressed air on the outlet port 51a side to flow toward the purge flow path inlet portion 56a is provided while branching from the outlet port 51a of the aforementioned outlet side casing main body 51 or the first piping 7 connected thereto, and an orifice 61 is disposed in the communicating path 60. In general, a flow amount of air flowing through the orifice 61 is set in a manner such that a minimal amount of the compressed air in the dehumidified compressed air flows through the purge flow path inlet portion 56a.

In the aforementioned membrane dryer 5, the high pressure air to be dehumidified, which is supplied from the piping connected to the inlet port 50a of the inlet side casing main body 50, is dehumidified by means of a difference of steam-partial pressure between the high pressure air and the purge air flowing through the purge flow path 56 on an outside of the hollow thread membrane 55a while flowing through the inside flow path of the hollow thread membrane 55a toward the outlet port 51a. The dehumidified compressed air is sent to the inlet 31 of the booster 3 upon passing through the outlet port 51a of the outlet side casing main body 51. On the other hand, the purge air whose humidity is raised in the aforementioned purge flow path 56 is discharged to ambient air through the purge flow path outlet portion 56b and the purge discharge outlet 56d. The aforementioned purge air is the used discharge air at low humidity from the drive chambers 41a and 41b of the booster 3, and the purge air is introduced to the purge flow path inlet portion 56a through the discharge outlet 45, the second piping 8, and the extraneous purge inlet port 56c.

Incidentally, since other construction and operation of the aforementioned second embodiment is the same as that of the first embodiment, the explanation thereof is omitted here.

1. A dehumidification system in a booster piping comprising:
a membrane dryer including,
an inlet port and an output port that is led to both ends of an inside flow path of a plurality of hollow thread membrane,
a purge flow path formed on an outside of the hollow thread membrane,
a purge flow path inlet portion and a purge flow path outlet portion respectively positioned at both end portions of the purge flow path, and
an extraneous purge inlet port that is allowed to communicate with the purge flow path inlet portion;
a booster including,
an inlet for introducing compressed air,
a drive chamber and a booster chamber, into which the compressed air from the inlet flows,
an outlet from which the compressed air boosted in the booster chamber by means of pressure of the drive chamber is discharged, and
a discharge outlet from which the used discharge air at low pressure, which is used for a boosting operation in the drive chamber, is discharged;
first piping causing the dehumidified compressed air discharged from the outlet port of the membrane dryer to flow toward the inlet of the booster; and
second piping causing the discharge air, which is used for a boosting operation, discharged from the discharge outlet of the booster to flow toward the purge flow path of the membrane dryer.

2. The dehumidification system according to claim 1, wherein the outlet port and the purge flow path inlet portion of the membrane dryer are connected to each other by means of a communicating path including an orifice.

3. The dehumidification system according to claim 2, wherein the purge flow path is provided in an inside of a U-shaped flow path case housing the hollow thread membrane upon curving the same, and both ends of the flow path case are coupled with a casing main body of the membrane dryer having the inlet port and the outlet port, and the orifice is provided inside the casing main body.

4. The dehumidification system according to claim 1, wherein the purge flow path is provided inside the flow path case formed to have a straight hollow-cylinder shape housing the hollow thread membrane.

5. The dehumidification system according to claim 2, wherein the purge flow path is provided inside the flow path case formed to have a straight hollow-cylinder shape housing the hollow thread membrane.

6. The dehumidification system according to claim 1, wherein an oil separation filter is provided in the second piping.

7. The dehumidification system according to claim 2, wherein an oil separation filter is provided in the second piping.

8. A dehumidification method in booster piping comprising the steps of:
dehumidifying compressed air at high pressure, to be dehumidified, by causing to flow into an inside flow path of a plurality of hollow thread membrane of a membrane dryer;
causing the dehumidified compressed air to flow into a drive chamber and a booster chamber of a booster;
supplying the compressed air that is boosted in the booster chamber by means of pressure in the drive chamber to a fluid pressure device; and
causing used discharge air at low pressure that is used for a boosting operation in the drive chamber to a purge flow path provided on an outside of the hollow thread membrane of the membrane dryer.

9. The dehumidification method in booster piping according to claim 8, wherein a part of the compressed air dehumidified in the membrane dryer is caused to flow through the purge flow path upon being depressurized.
